(19) United States
(12) Patent Application Publication
(10) Pub. No.: US 2021/0092000 A1
(43) Pub. Date: Mar. 25, 2021

(54) WEAKLY-SUPERVISED EVENT GROUPING ON INDUSTRIAL TIME-SERIES DATA

(71) Applicant: GENERAL ELECTRIC COMPANY, Schenectady, NY (US)

(72) Inventor: Hao Huang, San Ramon, CA (US)

(21) Appl. No.: 16/578,624

(22) Filed: Sep. 23, 2019

(51) Int. Cl. H04L 12/24; G05B 23/02; H04L 12/26

(52) U.S. Cl. CPC H04L 41/0631; G05B 23/0243; H04L 43/08; G05B 23/024; G05B 23/0281

(57) ABSTRACT

According to embodiments, a system, method and non-transitory computer-readable medium are provided to perform fault analysis of time series data including receiving a first set of time series data samples associated with one or more instances of one or more events of a piece of machinery, and receiving one or more labels identifying a relevance of a particular instance to a particular event. One or more event groups is determined based upon the data samples and the labels. Each event group is associated with one or more features of an event. Each data sample of a subset of the data samples is grouped into one of the event groups, and an event pattern is determined based upon the grouping. An event grouping model is constructed based upon the grouping. The event grouping model associates an event pattern with a particular feature of the one or more features of the event.

### BACKGROUND

Industrial machinery, such as turbines, are subject to failure for a variety of causes such as failure of an individual component of the machinery. Machinery failures are typically detected by sensors. Once a failure is detected by sensors, the failure is reported to an operator for correction. Recent advancement in industrial machinery design has led to the increasing need of developing data-driven analytic in various aspects including design, control, and operation optimization. Among these applications, machinery failure analysis is a long-standing crucial problem that can significantly benefit from data mining.

However, due to the complexity of system design and running conditions, events (e.g., cases of failure) usually belong to different event patterns (e.g., failure modes) which are usually unknown due to lack of enough prior knowledge. Without clear separation between the events, it is difficult for existing event detection methods to reach desirable accuracy. On the other hand, event grouping can assist in the understanding of the root cause of the events to support decision making and problem solving.

Therefore, it is beneficial to automatically cluster the events with only coarse binary labels for events and non-events. However, existing techniques typically focus either on purely unsupervised clustering only, or on supervised analysis which cannot discover different event patterns without further labels.

It would be desirable to provide systems and methods to discover event patterns that not only differentiate from healthy data but also differentiate from each other to improve the accuracy of event detection and pattern recognition in industrial time series data.

### SUMMARY

According to some embodiments, a computer-implemented method includes receiving a first set of time series data samples associated with one or more instances of one or more events of a piece of machinery, and receiving one or more labels identifying a relevance of a particular instance to a particular event. The embodiment further includes determining one or more event groups based upon the first set of time series data samples and the one or more labels. In the embodiment, each event group associated with one or more features of an event. The embodiment further includes grouping each data sample of a subset of the first set of time series data samples into one of the one or more event groups, and determining an event pattern based upon the grouping of the subset of the first set of time series data samples. The embodiment further includes constructing an event grouping model based upon the grouping, the event grouping model associating an event pattern with a particular feature of the one or more features of the event.

According to some embodiments, a system for event grouping on time-series data for diagnosis of machinery includes a processor; and a non-transitory computer readable medium comprising instructions that, when executed by the processor, perform a method. The method includes receiving a first set of time series data samples associated with one or more instances of one or more events of a piece of machinery, receiving one or more labels identifying a relevance of a particular instance to a particular event, and determining one or more event groups based upon the first set of time series data samples and the one or more labels. Each event group is associated with one or more features of an event. The method further includes grouping each data sample of a subset of the first set of time series data samples into one of the one or more event groups, and determining an event pattern based upon the grouping of the subset of the first set of time series data samples. The method further includes constructing an event grouping model based upon the grouping, the event grouping model associating an event pattern with a particular feature of the one or more features of the event.

According to some embodiments, a non-transitory computer-readable medium includes instructions that, when executed by the processor, perform a method. The method includes receiving a first set of time series data samples associated with one or more instances of one or more events of a piece of machinery, receiving one or more labels identifying a relevance of a particular instance to a particular event, and determining one or more event groups based upon the first set of time series data samples and the one or more labels. Each event group is associated with one or more features of an event. The method further includes grouping each data sample of a subset of the first set of time series data samples into one of the one or more event groups, and determining an event pattern based upon the grouping of the subset of the first set of time series data samples. The method further includes constructing an event grouping model based upon the grouping, the event grouping model associating an event pattern with a particular feature of the one or more features of the event.

### BRIEF DESCRIPTION OF THE DRAWINGS

FIG. 1 represents an example of event grouping of industrial time-series data for a case of multiple-instance binary classification.

FIG. 2A represents an example two-dimensional input dataset of industrial time-series data.

FIG. 2B shows the two-dimensional input dataset of FIG. 2A that has been labeled into event groups including true event-relevant samples according to a process described with respect to one or more embodiments.

FIG. 3 is a high-level architecture of a system for anomaly detection according to some embodiments.

FIG. 4 illustrates a process that might be performed by some of all of the elements of the system described with respect to FIG. 3 in accordance with some embodiments.

FIG. 5 is a block diagram of an evaluation platform according to some embodiments

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments provide for a weakly-supervised event grouping method that discovers event patterns that not only differentiate unhealthy data from healthy data but also differentiate data from each other to improve the accuracy of event detection and pattern recognition in industrial time series data. As used herein, the term “healthy data” refers to industrial time-series data that is not associated with a failure event, and the term “unhealthy data” refers to industrial time-series data that is associated with a failure event. Recent approaches have shown that by identifying event signatures, event pattern and potential features of root cause can be discovered. Despite their success, the existing methods have a major limitation in that they typically assume there is only a single failure mode among all the events. Other methods use generative clustering processes over the whole dataset while ignoring the separation between healthy and unhealthy data. In real world applications, there are two challenges: (1) it is very common that more than one failure mode exists which are usually unknown; and (2) not all of the instances labeled as potentially event-relevant are really with event patterns. Without solving the above challenges, it is difficult for existing methods to cluster events into the correct groups of failure modes.

One or more embodiments described herein provide for jointly selecting feature and time-instance data that is relevant to failure from multivariate multisource temporal data, providing a model to identify true event-relevant timestamps and grouping them into different types of events, and using selected features and instances to build more accurate multi-type event classifiers/detectors.

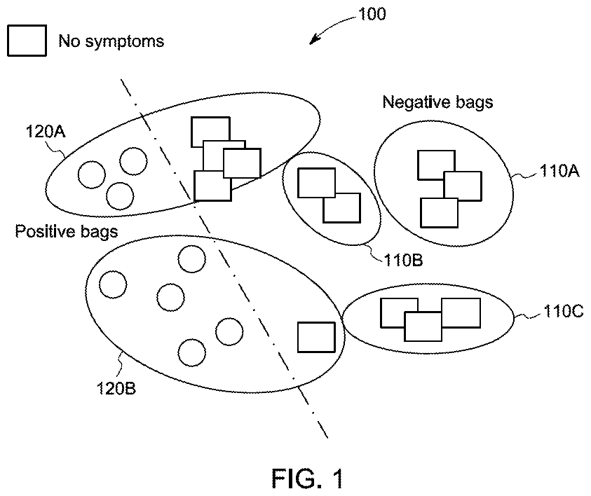

FIG. 1 represents an example of event grouping of industrial time-series data 100 for a case of multiple-instance binary classification. In the embodiment of FIG. 1, instead of receiving a set of instances that are individually labeled, a learner receives a set of labeled “bags”, each containing many instances. A negative instance is an instance that is not associated with a potential failure event, and a positive instance is an instance that is associated with a potential failure event. In the case of multi-instance binary classification, a bag may be labeled negative if all instances within the bag are negative. In the example illustrates in FIG. 1, bags 110A, 110B, and 110C include all negative instances and are consequently labeled as negative. On the other hand, a bag is labeled positive if at least one instance within the bag is positive. In the embodiment of FIG. 1, the instances within bags 120A and 120B include at least one positive instance and are labelled as positive. From a collection of labeled bags, the learn attempt to label individual instances correctly.

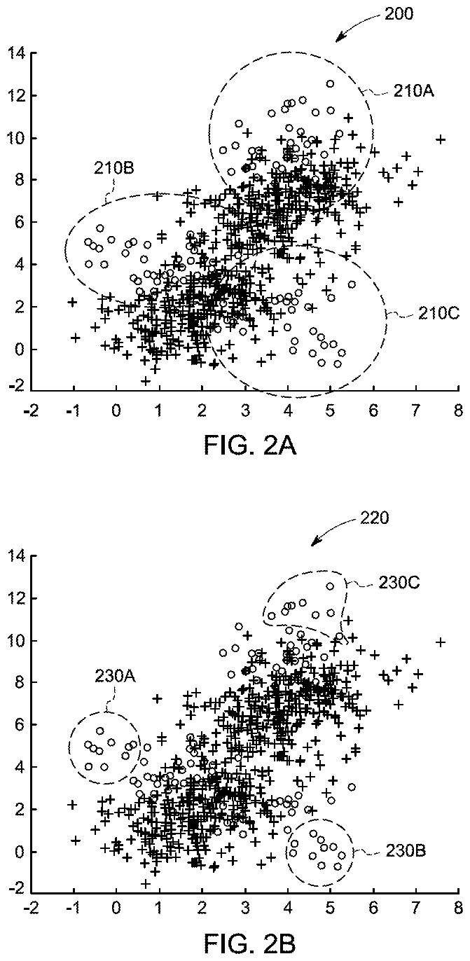

FIG. 2A represents an example two-dimensional input dataset 200 of industrial time-series data. Samples indicated by “+” are collected from healthy data, and samples indicated by “o” are collected from three events shown as bounded by three ellipses 210A, 210B, and 210C. FIG. 2A shows that there are different failure patterns for each of the events, and that most of the “o” samples are non-event-relevant since they are not separable from the “+” samples. Failure to separate different event patterns may lead to poor detection accuracy. However, if events can be successfully grouped into different classes, better detection performance is achieved as well as provides further ability to explain detect alerts such as the failure mode an alert belongs to, the event-relevant features, etc.

FIG. 2A further shows that not all of the samples collected from a timestamp close to events carry failure signatures, and only those event-relevant ones are of interest for failure detection and event grouping. In addition, non-event-relevant samples incorrectly labeled as event-relevant may negatively affect an event grouping model and decrease model performance.

FIG. 2B shows the two-dimensional input dataset of FIG. 2A that has been labeled into event groups including true event-relevant samples according to a process described with respect to one or more embodiments. The true event-relevant samples include samples with event patterns that differ from healthy data. FIG. 2B shows instances of “o” samples grouped into three different classes 230A, 230B, and 230C. The “o” samples not grouped within one of the three classes 230A, 230B, and 230C are identified as non-event-relevant according to the process of one or more embodiments.

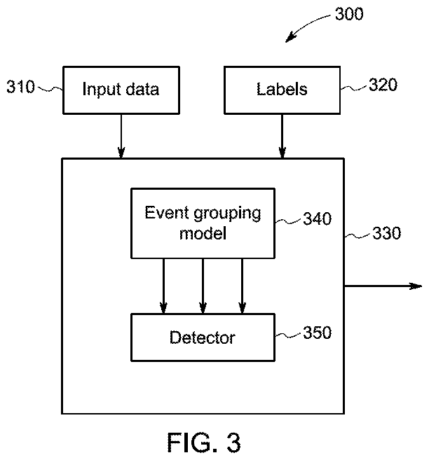

FIG. 3 is a high-level architecture of a system 300 for anomaly detection according to some embodiments. The system 300 may receive input data 310 associated with a number of events of a piece of machinery, and initial event-relevant labels 320 associated with the events. The input data 110 may be received at an evaluation platform 330 that comprises an event grouping model 340 and a detector 350. Event grouping model 340 and detector 350 may each be implemented as hardware or as software modules of the evaluation platform 330. In some embodiments, the detector 350 may comprise a plurality of detectors.

As used herein, devices, including those associated with the system 300 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The evaluation platform 330 may receive input data 310 and/or labels 320 from a plurality of sensors, from a database, or from another system such as an onboard data collection system. The database (not shown in FIG. 3), may be used by the evaluation platform 330 to store information into and/or retrieve information associated with a piece of machinery being evaluated on a periodic basis (e.g., daily, weekly, monthly). The database may be locally stored or reside remote from the evaluation platform 330. Although a single evaluation platform 330 is shown in FIG. 1, any number of such devices may be included. Moreover, various devices described herein might be combined according to embodiments of the present invention. For example, in some embodiments, the evaluation platform 330 and database might comprise a single apparatus. In some embodiments, the input data 310 may be received in real-time from the plurality of sensors or another system

For greater ease of understanding, some formal mathematical notations are introduced as follows: For a matrix Z∈ [symbol] ^{m×n}, Z^{T} denotes its transpose and Z^{T} denotes its (pseudo)inverse, while Z(i, j) denotes the element in the i-th row and j-th column, and Z(I, :) and Z(:,j) denote its i-th row and j-th column respectively. Entry-wise norms are denoted by ∥Z∥ₚ, where p=2 gives Frobenius norm ∥Z∥_{F}=\sqrt{Σᵢⱼ(i, j)²}=\sqrt{tr(ZZ^{T})}, and p=(2,1) gives l_{2,1} norm ∥Z∥_{2,1}=Σᵢ₌₁^{m}∥Z(i,;)∥₂. For a vector [w₁, . . . , wₘ]∈ [symbol] ^{m×n}, diag([w₁, . . . , wₘ])∈ [symbol] ^{m×n} denotes a diagonal matrix with w₁, . . . , wₘ, as its diagonal entries while diag(Z) for a given square matrix Z is a square matrix that has the same diagonal entries as Z but off-diagonal entries are all zeros. [symbol] ₘ is an identity matrix of dimension m×n.

In an example operation of evaluation platform 330, consider a failure analytic task with k available events. In an embodiment, the evaluation platform 330 collects collect samples from the k events and additional samples from healthy data. Each instance has m-dimensional features. Event grouping model 340 receives input data 310 and initial labels 320. Input data 310 includes samples collected from each event as is large enough to include the event-relevant samples. Thus, the input data 310 may include a data matrix organized as X=[x₁, x₂, . . . , xₙ]=[Xₐ, X_{b}]∈ [symbol] ^{m×m}, where n is the number of all instances, a:=kn, b:=h−kn, Xₐ=[x₁, x₂, . . . , xₐ]∈ [symbol] ^{m×a} are instances from all of the events, X_{b}=[xₐ₊₁, xₐ₊₂, . . . , x_{a+b}]∈ [symbol] ^{m×b} are all of the normal instances collected from healthy samples (irrelevant to the event), with usually b>>a.

For initial labels 320, an initial event-relevant label matrix is denoted as E∈{0, 1}^{k×n}, where E(j, =1 if xᵢ is an instance collected from the j-th event, otherwise E(j, i)=0.

Event grouping model 340 provides as a model output:
(1) An instance weighting matrix as Y∈ [symbol] ^{k×n} where the value of Y(j, i) represents the relevance of instance xᵢ to the j-th event;
(2) An indicator matrix of different event groups as H★ [symbol] ^{k×h}, where h is set as the number of event groups, and a high value of H(j, i) represents that the j-th event belongs to the i-th event group I; and
(3) A centroid matrix of event groups as G∈ [symbol] ^{h×m}, where G(j,:) represents the centroid of the j-th event group.

Therefore, Y provides the true event relevant samples, H provides the event grouping information, and G provides the event patterns (i.e., event signatures). E and Y can be written as E=[Eₐ, E_{b}] and Y=[Yₐ, Y_{b}], where Eₐ∈{0, 1}^{k×a} and Yₐ∈ [symbol] ^{k×a} correspond to the instances from Xₐ, and E_{b}=Y_{b}=0^{k×b} correspond to normal instances from X_{b}.

An objective function is given by the following equation:

$$J ( H , G , {Y}_{a} ) = {min}_{H , G , {Y}_{a}} α {‖ {HGX}_{a}^{T} - {Y}_{a}^{T} ‖}_{F}^{2} + β {‖ {HGX}_{b}^{T} - {E}_{b}^{T} ‖}_{F}^{2} + γ {‖ {G}^{T} ‖}_{2 , 1} s . t . {Y}_{a}^{T} 1 = 1 \qquad ( Equation 1 )$$

where H∈ [symbol] ^{k×h} is the indicator matrix of cluster membership, G∈ [symbol] ^{h×m} is the centroid matrix of cluster, k is the number of events and h is the number of event clusters (h<k). An iterative solution to solve Equation 1 is as follows:

Given H and G, the optimal Yₐ can be computed by:

Ya=(HGXₐ^{T})^{T}⊗Eₐ, (Equation 2)

where ⊗ denotes Hadamard product (i.e., element-wise product).

Given Ya and H, the optimal G can be computed by:

G=((α(Xₐ^{T}Xₐ)+β(X_{b}^{T}X_{b})+γD_{G})⁻¹(α(Xₐ^{T}Yₐ)H⁻¹^{^{T}}))^{T} (Equation 3)

where D_{G} is a diagonal matrix with the i-th diagonal element as

$${D}_{G} ( i , i ) = \frac{1}{2 {‖ G ( i , \text{:} ) ‖}_{2}} .$$

Given Ya and W, the optimal H can be computed by:

H=H( [symbol] ₘ_{_{0.5}}*( [symbol] ₘ−H^{T}H) (Equation 4)

where H is initialized by a non-negative least squares result from nnls(XG,

After convergence, the matrix H is the event pattern indicator matrix, where each row corresponds to one event and each column represents one event pattern. The larger the value of H, the more likely the event belongs to that pattern. Matrix G indicates how each pattern appears on the feature space, i.e. which features are the most contributing to separate such pattern from the healthy event patterns and other event patterns.

In an example algorithm computed by evaluation platform 330 according to a particular embodiment is as follows:
Input: X, E, α, β, γ,
X=[Xₐ, X_{b}]∈ [symbol] ^{m×n} where n is the number of instances and m is the number of features, while Xₐ∈ [symbol] ^{m×a} corresponds to the instances initially labeled as “1” and X_{b}∈ [symbol] ^{m×b} are those initially labeled as “0” (usually b>>a). E∈ [symbol] ^{k×n} to be the initial event labels, where E(j,i)=1 if xᵢ is initialized as one of the event instances for the j-th event, otherwise E(j,i)=0.
Output: The instance weighting matrix Y∈ [symbol] ^{k×n} the indicator matrix of different event groups H∈ [symbol] ^{k×h}, and the centroid matrix of event groups G∈ [symbol] ^{h×m}.
Initialize Y=E and Yₐ to be the first a columns of Y;
Initialize Dw= [symbol] ;
Initialize H and G with a random generated matrix; while
   Not convergent do
      Calculate Yₐ using Equation 2;
      Calculate G using Equation 3;
      Calculate H using Equation 4;
   end while;

After convergence, the evaluation platform 330 constructs the event grouping model 340 based upon the converged matrices Y, H, and G. The detector 350 may use the event grouping model 340 to determine anomalies associated with the input data subsequent input data 310 that does not include training data. Once anomalies are detected, the detected anomalies may be evaluated to determine if a level or amount of anomalies reaches a threshold that triggers an alert to an operator. By alerting an operator to anomalies prior to an actual failure, repair costs of the machinery may be reduced, and the safety of the machinery may be increased. For example, in a case that a bearing, or an unknown fault, in an aircraft engine is showing signs of degradation, the bearing may be replaced prior to actual engine damage or a risk to passengers. Similarly, the unknown fault may be addressed prior to actual engine damage and passenger risk.

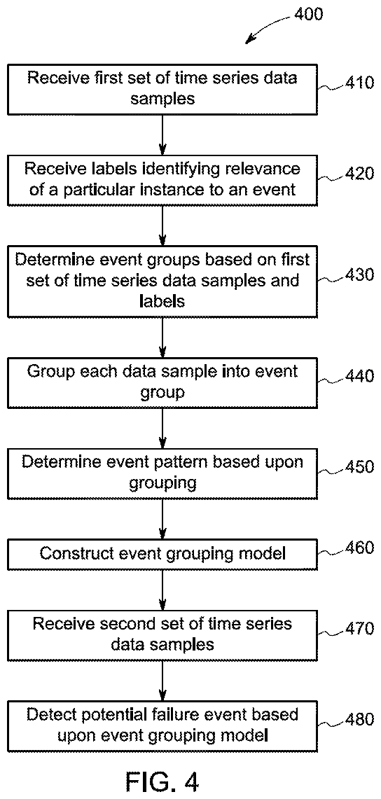

FIG. 4 illustrates a process 400 that might be performed by some of all of the elements of the system 300 described with respect to FIG. 3 in accordance with some embodiments. Process 400, and any other process described herein may be performed using any suitable combination of hardware (e.g., circuit(s)), software or manual means. For example, a computer-readable storage medium may store thereon instructions that when executed by a machine result in performance according to any of the embodiments described herein. In one or more embodiments, the system 300 is conditioned to perform the process 400 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto. The flow charts described herein do not imply a fixed order to the steps, and embodiments of the present invention may be practiced in any order that is practicable.

Initially, at 410, the evaluation platform 330 receives a first set of time series data samples associated with one or more instances of one or more events of a piece of machinery. At 420, the evaluation platform 330 receives one or more labels identifying a relevance of a particular instance to a particular event. At 430, the evaluation platform 330 determines one or more event groups based upon the first set of time series data samples and the one or more labels. In an embodiment, each event group is associated with one or more features of an event.

At 440, the evaluation platform 330 groups each data sample of a subset of the first set of time series data samples into one of the one or more event groups. At 450, the evaluation platform 330 determines an event pattern based upon the grouping of the subset of the first set of time series data samples. At 460, the evaluation platform 330 constructs an event grouping model based upon the grouping. The event grouping model associates an event pattern with a particular feature of the one or more features of the event. In a particular embodiment, the event grouping model includes the event grouping model 340 of FIG. 3.

In one or more embodiments, constructing the event grouping model further includes computing an instance weighting matrix representative of a relevance of an instance to a particular event, computing an indicator matrix of different event groups of the one or more event groups in which the indicator matrix represents an indication of a particular event belonging to a particular group, and computing a centroid matrix of event groups, the centroid matrix representing a centroid of each of the event groups.

In one or more embodiments, the instance weighting matrix, the indicator matrix, and the centroid matrix are iteratively calculated until the indicator matrix is determined to be converged. In particular embodiments, each row of the converged the indicator matrix corresponds to one event and each column represents one event pattern.

In one or more embodiments, computing the instance weighting matrix is based upon the indicator matrix, the centroid matrix, and the first set of time series data samples. In one or more embodiments, computing the centroid matrix is based upon the first set of time series data samples, the instance weighting matrix, and the indicator matrix.

At 470, the evaluation platform 330 receives a second set of time series data samples associated with the piece of machinery. At 480, the evaluation platform 330 detects a potential failure event associated with the piece of machinery based upon the second set of time series data samples and the event grouping model.

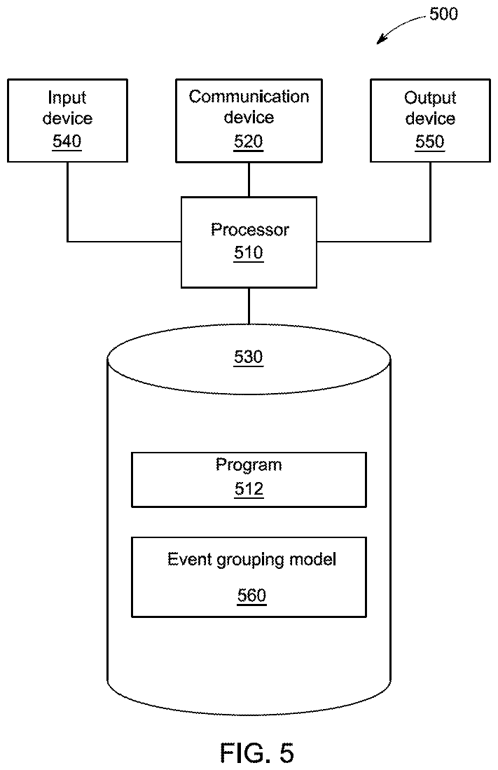

The embodiments described herein may be implemented using any number of different hardware configurations. For example, FIG. 5 is a block diagram of an evaluation platform 500, for example, associated with the system 300 of FIG. 3, according to some embodiments. The evaluation platform 500 comprises a processor 510, such as one or more commercially available Central Processing Units (“CPUs”) in the form of one-chip microprocessors, coupled to a communication device 520 configured to communicate via a communication network (not shown in FIG. 5). The communication device 520 may be used to communicate, for example, with one or more remote data source nodes, user platforms, etc. The evaluation platform 500 further includes an input device 540 (e.g., keyboard or mouse) and/an output device 550 (e.g., a computer monitor to render a display). According to some embodiments, a mobile device, monitoring physical system, and/or PC may be used to exchange information with the evaluation platform 500.

The processor 510 also communicates with a storage device 530. The storage device 530 may comprise any appropriate information storage device, including combinations of magnetic storage devices (e.g., a hard disk drive), optical storage devices, mobile telephones, and/or semiconductor memory devices. The storage device 530 stores a program 512 for controlling the processor 510. The processor 510 performs instructions of the program 512 and thereby operates in accordance with any of the embodiments described herein. The storage device 530 further stores an event grouping model 560 such as event grouping model 340 of FIG. 3.

The program 512 may be stored in a compressed, uncompiled and/or encrypted format. The program 512 may furthermore include other program elements, such as an operating system, clipboard application, a database management system, and/or device drivers used by the processor 510 to interface with peripheral devices.

As used herein, information may be “received” by or “transmitted” to, for example: (i) the evaluation platform 500 from another device; or (ii) a software application or module within the evaluation platform 500 from another software application, module, or any other source.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method comprising:
receiving a first set of time series data samples associated with one or more instances of one or more events of a piece of machinery;
receiving one or more labels identifying a relevance of a particular instance to a particular event;
determining one or more event groups based upon the first set of time series data samples and the one or more labels, each event group associated with one or more features of an event;
grouping each data sample of a subset of the first set of time series data samples into one of the one or more event groups;
determining an event pattern based upon the grouping of the subset of the first set of time series data samples; and
constructing an event grouping model based upon the grouping, the event grouping model associating an event pattern with a particular feature of the one or more features of the event.

2. The method of claim 1, wherein constructing the event grouping model further comprises:
computing an instance weighting matrix representative of a relevance of an instance to a particular event;
computing an indicator matrix of different event groups of the one or more event groups, the indicator matrix representing an indication of a particular event belonging to a particular group; and
computing a centroid matrix of event groups, the centroid matrix representing a centroid of each of the event groups.

3. The method of claim 2, further comprising:
iteratively calculating the instance weighting matrix, the indicator matrix, and the centroid matrix until the indicator matrix is determined to be converged.

4. The method of claim 3, wherein each row of the converged the indicator matrix corresponds to one event and each column represents one event pattern.

5. The method of claim 2, wherein computing the instance weighting matrix is based upon the indicator matrix, the centroid matrix, and the first set of time series data samples.

6. The method of claim 2, wherein computing the centroid matrix is based upon the first set of time series data samples, the instance weighting matrix, and the indicator matrix.

7. The method of claim 1, further comprising:
receiving a second set of time series data samples associated with the piece of machinery;
detecting a potential failure event associated with the piece of machinery based upon the second set of time series data samples and the event grouping model.

8. A system for event grouping on time-series data for diagnosis of machinery comprising:
a processor; and
a non-transitory computer readable medium comprising instructions that, when executed by the processor, perform a method, the method comprising:
receiving a first set of time series data samples associated with one or more instances of one or more events of a piece of machinery;
receiving one or more labels identifying a relevance of a particular instance to a particular event;
determining one or more event groups based upon the first set of time series data samples and the one or more labels, each event group associated with one or more features of an event;
grouping each data sample of a subset of the first set of time series data samples into one of the one or more event groups;
determining an event pattern based upon the grouping of the subset of the first set of time series data samples; and
constructing an event grouping model based upon the grouping, the event grouping model associating an event pattern with a particular feature of the one or more features of the event.

9. The system of claim 8, wherein constructing the event grouping model further comprises:
computing an instance weighting matrix representative of a relevance of an instance to a particular event;
computing an indicator matrix of different event groups of the one or more event groups, the indicator matrix representing an indication of a particular event belonging to a particular group; and
computing a centroid matrix of event groups, the centroid matrix representing a centroid of each of the event groups.

10. The system of claim 9, wherein the method further comprises:
iteratively calculating the instance weighting matrix, the indicator matrix, and the centroid matrix until the indicator matrix is determined to be converged.

11. The system of claim 10, wherein each row of the converged the indicator matrix corresponds to one event and each column represents one event pattern.

12. The system of claim 9, wherein computing the instance weighting matrix is based upon the indicator matrix, the centroid matrix, and the first set of time series data samples.

13. The system of claim 9, wherein computing the centroid matrix is based upon the first set of time series data samples, the instance weighting matrix, and the indicator matrix.

14. The system of claim 8, wherein the method further comprises:
receiving a second set of time series data samples associated with the piece of machinery;
detecting a potential failure event associated with the piece of machinery based upon the second set of time series data samples and the event grouping model.

15. A non-transitory computer-readable medium comprising instructions that, when executed by the processor, perform a method, the method comprising:
receiving a first set of time series data samples associated with one or more instances of one or more events of a piece of machinery;
receiving one or more labels identifying a relevance of a particular instance to a particular event;
determining one or more event groups based upon the first set of time series data samples and the one or more labels, each event group associated with one or more features of an event;
grouping each data sample of a subset of the first set of time series data samples into one of the one or more event groups;
determining an event pattern based upon the grouping of the subset of the first set of time series data samples; and
constructing an event grouping model based upon the grouping, the event grouping model associating an event pattern with a particular feature of the one or more features of the event.

16. The non-transitory computer-readable medium of claim 15, wherein constructing the event grouping model further comprises:
computing an instance weighting matrix representative of a relevance of an instance to a particular event;
computing an indicator matrix of different event groups of the one or more event groups, the indicator matrix representing an indication of a particular event belonging to a particular group; and
computing a centroid matrix of event groups, the centroid matrix representing a centroid of each of the event groups.

17. The non-transitory computer-readable medium of claim 16, wherein the method further comprises:
iteratively calculating the instance weighting matrix, the indicator matrix, and the centroid matrix until the indicator matrix is determined to be converged.

18. The non-transitory computer-readable medium of claim 17, wherein each row of the converged the indicator matrix corresponds to one event and each column represents one event pattern.

19. The non-transitory computer-readable medium of claim 16, wherein computing the instance weighting matrix is based upon the indicator matrix, the centroid matrix, and the first set of time series data samples.

20. The non-transitory computer-readable medium of claim 16, wherein computing the centroid matrix is based upon the first set of time series data samples, the instance weighting matrix, and the indicator matrix.
